(19) United States
(12) Patent Application Publication
(10) Pub. No.: US 2006/0282312 A1
(43) Pub. Date: Dec. 14, 2006

(54) Advertisements in an alert interface

(75) Inventors: Matthew C. Carlson, Redmond, WA (US); Todd S. Biggs, Redmond, WA (US); Mark T.K. Looi, Redmond, WA (US)

Correspondence Address: VIERRA MAGEN/MICROSOFT CORPORATION, 575 MARKET STREET, SUITE 2500, SAN FRANCISCO, CA, 94105, US

(73) Assignee: Microsoft Corporation, Redmond, WA (US)

(21) Appl. No.: 11/150,004

(22) Filed: Jun. 10, 2005

(51) Int. Cl. G06Q 30/00

(52) U.S. Cl. 705/14

(57) ABSTRACT

Advertisements are incorporated into alerts generated for a user. A server-side alert delivery system can be used by a partner server, client device, or other server to deliver an alert to a user about some event the user has requested. A relevant advertisement is selected based upon the content of the alert and other data. In some cases, the time of day of the alert and/or the location to which the alert is delivered may be considered in selecting the advertisement. The alert may be provided to a user through different services and devices, including an instant messaging service, mail service, or through a mobile device.

### BACKGROUND OF THE INVENTION

1. Field of the Invention

The present invention is directed to providing advertisements to a user, and more specifically to providing advertising to a user through an alert service.

2. Description of the Related Art

A large number of people spend considerable time browsing content over the Internet. As a result, advertising over the Internet has become very popular. Currently, advertisements are reactively selected for Internet users. First, user data is captured by a network browser application. The data may include a number of websites the user has accessed. For example, a network browser stores information, such as a URL, regarding the web sites that a user has accessed in the form of a cookie file. Web services can then access the stored information and determine advertisements that relate to the websites previously accessed by the user. For example, if the stored information indicates a user has visited a travel planning web site, an advertisement may be selected regarding travel planning web services.

Selecting advertisements for a user based on past information has disadvantages. In particular, the advertisements are selected in response to previously accessed web sites. Thus, advertisements are selected for a user some time after the user has shown an interest in the particular website. This can result in selection of an out-dated advertisement for the user. Furthermore, this type of advertisement selection requires enablement of cookies by the user, which is not always the case. However, even if cookies are enabled for a user, if a user browses the Internet on different machines (for example, a work machine and a home machine), neither machine will have a full record of the user's website access history. This results in a degraded relevancy of the advertisements selected for the user.

### SUMMARY OF THE INVENTION

The technology herein, roughly described, relates to advertisements placed in alerts generated for a user. A proactive targeted advertising system uses an alert delivery system to generate and deliver advertisements. The alerts can be provided to a user based on the user's request for the alerts. A server-side alert delivery system can be used by a partner server, client device, or other server to deliver an alert to a user about some event the user has requested. The targeted advertising system is linked to the alert delivery system to select an advertisement based upon the content of the alert and other data. In some cases, the time of day of the alert and/or the location to which the alert is delivered may be considered in selecting the advertisement.

In one embodiment, a method for providing an alert begins with receiving event data associated with an alert for a user. A relevant advertisement associated with the event data can then be determined. A relevant advertisement and the alert are then provided to the user.

In one embodiment, a system for providing an alert may include an alert generation engine and an alert delivery engine. The alert generation engine may generate an alert in response to receiving event data for an alert. The alert may include alert data and advertisement data. The alert delivery engine may be able to deliver the alert to a user.

In one embodiment, a method for providing an alert may begin with receiving alert data and advertisement data by an application. The alert data and advertisement data are associated with a user. Next, the alert data and advertisement data are provided to the user in an alert interface.

### BRIEF DESCRIPTION OF THE DRAWINGS

FIG. 1 illustrates an embodiment of a system for implementing relevant advertisements in user notifications.

FIG. 2 illustrates an embodiment of a computing environment for implementing the present invention.

FIG. 3 illustrates an example of a sequence diagram for partner-side generation of an alert.

FIG. 4A illustrates a method for partner-side generation and delivery of an alert having an advertisement.

FIG. 4B illustrates an alert interface having an advertisement.

FIG. 5 illustrates an example of a sequence diagram for server-side generation of an alert.

FIG. 6 illustrates an embodiment of a method for server-side generation and delivery of an alert having an advertisement.

FIG. 7 illustrates an embodiment of a sequence diagram of server-side generation of an alert having an advertisement.

FIG. 8 illustrates an embodiment of a method for server-side generation and delivery of an alert having an advertisement.

FIG. 9 illustrates a sequence diagram of client-side generation of an alert having an advertisement.

FIG. 10 illustrates an embodiment of a method of client-side generation and delivery of an alert.

### DETAILED DESCRIPTION

In accordance with one embodiment of the invention, advertisements are incorporated into alerts which are generated for a user. Advertisements are proactively generated and then delivered by an alert delivery system. The alerts can be provided to a user based on user alert routing preferences. User alert routing preferences may include preferences for routing alerts to a user, whether or not to include advertisements in user alerts, and other preferences. A server-side alert delivery system can be used by a partner server, client device, or other server to deliver an alert to a user about some event the user has requested to be notified about. A relevant advertisement is selected based upon the content of the alert, content associated with a link within the alert and other data. In some cases, the time of day of the alert and/or the location to which the alert is delivered may be considered in selecting the advertisement.

In operation, an event associated with a user is detected. An alert is subsequently generated from data associated with the event. Event data, alert data and/or other data is then used to select a relevant advertisement for the user. Additional data my be retrieved from several sources at the same time or some time before the advertisement is selected. The selected alert and relevant advertisement is then provided to a user. In some embodiments, the alert may be provided to a user through different services or devices, including an instant messaging service, mail service, or through a mobile device. Using event data, user data and/or alert data to select advertisements proactively can result in an improved relevancy of the advertisement.

In one embodiment, an advertisement is information that may be provided within an alert for a user regarding a product, service or event related to the alert. An advertisement may consist of text, images, video, animation, audio, or some combination of these. In addition, additional content may be associated with the advertisement. For example, a URL may be associated with the text, image(s), video, or animation of an advertisement.

In one embodiment, the advertisement provided with the alert is determined to be relevant to the alert. Relevancy of an advertisement to an alert, or event, is improved by increasing the number of metrics provided to the advertisement targeting system. Metrics are used by the advertisement targeting system to determine an advertisement for a user. Relevancy metrics may include key words in alert content or content associated with a link within the alert, user metadata, the time an alert is generated and/or delivered, a device on which the alert is displayed, user location, user actions, or other information associated with the user. Key words may include alert content or key words in a query used to generate the alert. Metadata may include data related to the categorization of the type of content being sent, such as sports, travel, weather, information about categories of other alerts the user subscribes to, or other data.

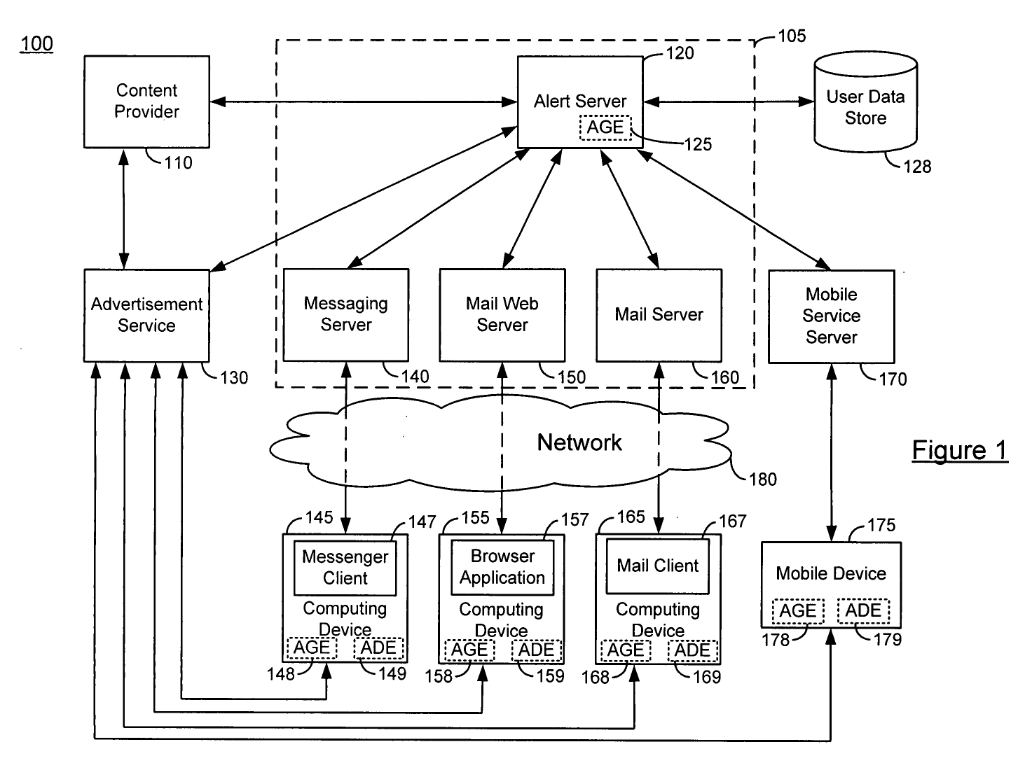

FIG. 1 illustrates an embodiment of a system 100 for implementing relevant advertising in user alert. System 100 includes content provider 110, relevant advertisement generation system 105, user data store 128, advertisement service 130, mobile service server 170, computing device 145, computing device 155, computing device 165, and mobile device 175. Relevant advertisement generation system 105 includes alert server 120, messaging server 140, mail web server 150, and mail server 160. System 105 communicates with content provider 110, advertisement service 130, user data store 128, mobile service provider 170, computing devices 145-165, and mobile device 175 over network 180. In one embodiment, network 180 may be the Internet.

System 100 of FIG. 1 may include one or more implementations of an advertisement generation engine (AGE). An AGE retrieves advertisements from advertisement service 130 and combines advertisement data with event data for display in an alert interface. An AGE may be implemented in several elements of system 100, including alert server 120, one or more of computing devices 145-165, and mobile device 175. Retrieval of a relevant advertisement using event and/or alert data and combination of the data with alert data is discussed in more detail below.

System 100 of FIG. 1 may also include one or more implementations of an advertisement display engine (ADE). An ADE displays alert data and relevant advertisement data in an alert interface. The ADE receives the alert data and relevant advertisement data from an AGE. The alert interface, including the alert and the advertisement, is displayed by methods known in the art. An ADE may differ from device to device (for example, from computer to mobile device) in order to display an alert interface on displays associated with the particular device. An ADE may be implemented in several elements of system 100, including any of computing devices 145-165 and mobile device 175. Display and interaction with an alert interface is discussed in more detail below.

Content provider 110 may be implemented as a third party web service. The web service may provide content to users and other web services. The information may include event data associated with a particular user. The event data may be used to generate an event by alert server 120. For example, content provider 110 may provide event data regarding the weather, such as forecasts and current weather conditions. As another example, client content provider 110 may provide event data regarding sports scheduling information, such as sport and team information. Content provider 110 may send and receive messages with alert server 120 and advertisement service 130.

Alert server 120 is located within relevant advertisement generation system 105. Alerts can be processed and managed by alert server 120 for users of different services. In particular, alert server 120 manages alert subscriptions, receives alert event messages, retrieves advertisement data, and transmits alerts to users through different channels. The channels may include web-based mail, client application-based mail, instant messaging services, and mobile devices. In one embodiment, alert server 120 may also maintain and access user settings for receiving alerts. For example, alert server 120 may confirm a user has subscribed to receive advertisements in an alert. The confirmation can be done locally or by querying a remote server, such as user data store 128. As indicated in FIG. 1, alert server 120 may include AGE 125. Alert server 120 may transmit and receive messages from user data store 128, content provider 110, advertisement service 130, messaging server 140, mail web server 150, mail server 160 and mobile server 170.

User data store 128 stores data and other information for users of the relevant advertisement generation system 105. The stored information can include data such as user account data for a mail provider service, user contact lists, user alert subscription information, user instant messaging account information, user mobile device account information, and other data. The data received from user data store 128 can be used to increase the relevancy of an advertisement generated for a user in an alert. This is discussed in more detail below.

Advertisement service 130 can provide, or select, a relevant advertisement in response to receiving user and event information. In one embodiment, advertisement service 130 is the portion of an advertisement targeting system that selects the relevant add based on known metrics. Typically, advertisement service 130 is implemented outside relevant advertisement generation system 105. In an example of advertisement selection, advertisement service 130 may receive associated with a football game. In particular, the event data may indicate that the game will be televised during the evening of the current day. The advertisement service can select an advertisement associated with this event data, including the time of day, location of the user, and content of the event data. In the example, the selected advertisement may relate to a pizza delivery service. The service can be selected such that it is available within the user's geographic area during the time of the sporting event mentioned in the alert. After selecting a relevant advertisement, advertisement service 130 may transmit the advertisement back to the requesting source. Advertisement service 130 may receive and transmit information with content provider 110, alert server 120, computing devices 145-165, and mobile device 175. Advertising service 130 is discussed in more detail below.

Messaging server 140 implements the server side operation of an instant messaging service. In particular, instant messages sent and received by a user from a messenger client application or web based messaging application are sent and received through messaging server 140. Additionally, alerts displayed to a user by a messaging application on a client device are sent to the client by messaging server 140. Messaging server 140 may send and receive information with alert server 120 and computing device 145 and is discussed in more detail below.

Mail web server 150 implements a web-based mail service for users that subscribe to the mail service. In particular, users may access and manage a web-based mail account using a browser application in communication with mail web server 150. Mail web server 150 may send and receive messages with alert server 120 and computing device 155, and is described in more detail below.

Mail server 160 implements a mail service with users that implement a mail client application on a remote computing device. Mail server 160 may send and receive messages and alert data with alert server 120 and computing device 165. Mobile service server 170 implements a messaging service for mobile devices, such as mobile device 175. In particular, mobile service server 170 may send and receive text and other message data with mobile device 175. Mobile server 170 sends and receives information with alert server 120 and mobile device 175.

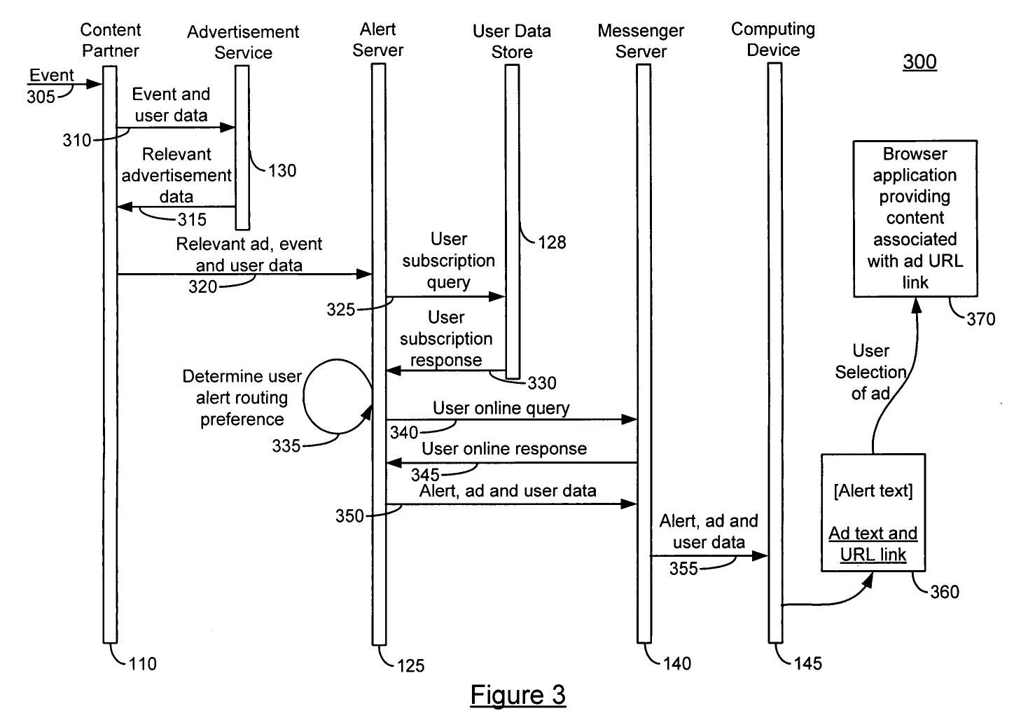

Computing devices 145-165 may send and receive information with the relevant advertisement generation system 105 through network 180. Computing device 145 may include messenger client application 147, AGE 148, and ADE 149. Users can log into an instant messaging service through messaging server 140 with messenger client 147. Alerts may be transmitted to computing device 145 by messaging server 140 and displayed on a display device by messenger client 147. In some embodiments, an alert may be generated by AGE 148. In this case, AGE 148 may retrieve a relevant advertisement from the alert data and provide the advertisement and alert in an alert interface. The alert interface may be displayed for a user by ADE 149. In some embodiments, alert data and advertising data may both be received by computing device 145. This is discussed in more detail below with respect to FIGS. 3-6.

Computing device 155 includes browser application 157, AGE 158 and ADE 159. A user having an account with a web-based mail service provider may access their mail through browser application 157. Alerts may be delivered to the user's web-based mail account and accessed through browser application 157. In one embodiment, the browser application may generate ads using AGE 158 and display ads using ADE 159. This may be performed in a similar manner to that discussed with respect to computing device 145 in FIGS. 3-6.

Computing device 165 includes mail client 167, AGE 168 and ADE 169. A user may access mail using mail client 167 of computing device 165. A user may also receive an alert as an electronic message through mail client 167. In this case, mail client 167 may generate alerts using AGE 168 and display alerts using ADE 169. This may be performed in a similar manner to that discussed with respect to computing device 145 in FIGS. 3-6.

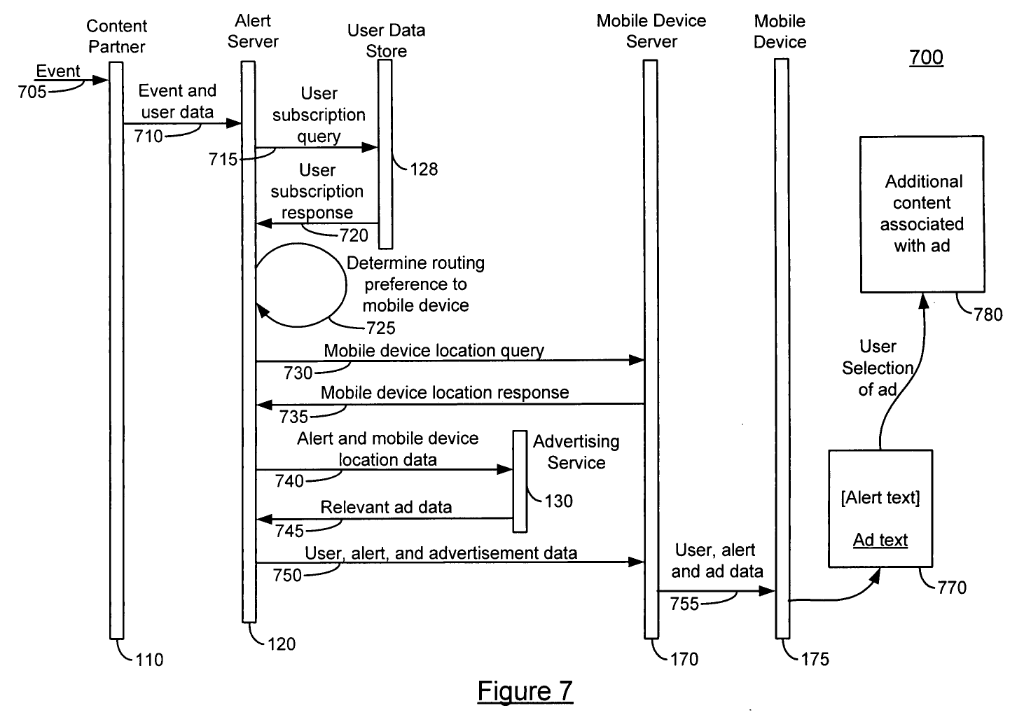

Mobile service server 170 may be used to provide message data and alerts to a user through mobile device 175. In this case, mobile device 175 may receive alert data or generate alerts using AGE 178. The generated alerts may be displayed to a user on mobile device 175 by ADE 179. Mobile device 175 may include any device that is able to remotely communicate with a network. This may include, but is not limited to, wireless personal digital assistants (PDAs), handsets, cameras, notebooks, laptop computers, cellular and other wireless phones, and other devices. This is discussed in more detail below with respect to FIGS. 7-10.

In one embodiment, a system 100 for implementing relevant advertising in an alert may include an entertainment device. The entertainment device may be configured to provide alerts to a user. For example, an entertainment unit, such as a gaming console or web-television unit, may receive alert data directly or indirectly from alert server 120. In this case, the entertainment unit may provide an alert with a relevant advertisement while also providing entertainment content (such as a game, television programming, or Internet content) to a user. The alert may be selected based on the event or alert data as well as data from the entertainment device. Entertainment device data may include game information, the location of the device, the number of players playing, the television program being viewed, and other information. As discussed above, the alerts may include text, images, video, audio, animation, and other media.

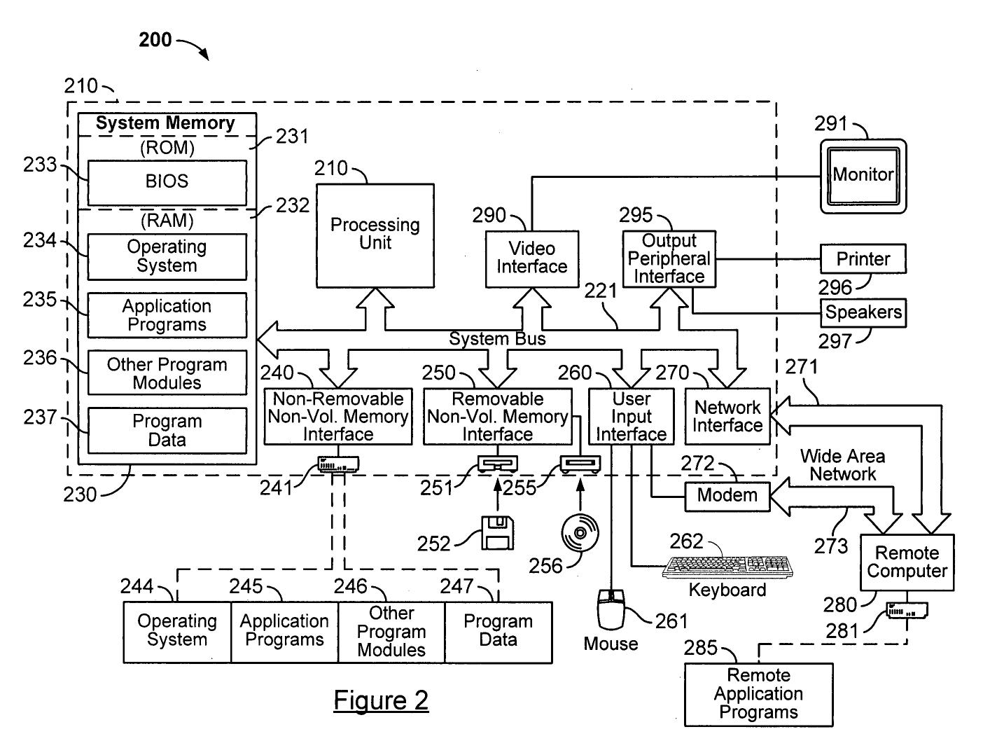

FIG. 2 illustrates an embodiment of a computing environment 200 for implementing the present invention. In one embodiment, computing environment 200 may be used to implement content provider 110, alert server 120, user data store 128, advertisement service 130, messaging server 140, mail web server 150, mail server 160, mobile service server 170, computing devices 145-165, and mobile device 175.

FIG. 2 illustrates an example of a suitable computing system environment 200 on which the invention may be implemented. The computing system environment 200 is only one example of a suitable computing environment and is not intended to suggest any limitation as to the scope of use or functionality of the invention. Neither should the computing environment 200 be interpreted as having any dependency or requirement relating to any one or combination of components illustrated in the exemplary operating environment 200.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 2, an exemplary system for implementing the invention includes a general purpose computing device in the form of a computer 210. Components of computer 210 may include, but are not limited to, a processing unit 220, a system memory 230, and a system bus 221 that couples various system components including the system memory to the processing unit 220. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. A basic input/output system 233 (BIOS), containing the basic routines that help to transfer information between elements within computer 210, such as during start-up, is typically stored in ROM 231. RAM 232 typically contains data and/or program modules that are immediately accessible to and/or presently being operated on by processing unit 220. By way of example, and not limitation, FIG. 2 illustrates operating system 234, application programs 235, other program modules 236, and program data 237.

The computer 210 may also include other removable/non-removable, volatile/nonvolatile computer storage media. By way of example only, FIG. 2 illustrates a hard disk drive 240 that reads from or writes to non-removable, nonvolatile magnetic media, a magnetic disk drive 251 that reads from or writes to a removable, nonvolatile magnetic disk 252, and an optical disk drive 255 that reads from or writes to a removable, nonvolatile optical disk 256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 is typically connected to the system bus 221 through an non-removable memory interface such as interface 240, and magnetic disk drive 251 and optical disk drive 255 are typically connected to the system bus 221 by a removable memory interface, such as interface 250.

The drives and their associated computer storage media discussed above and illustrated in FIG. 2, provide storage of computer readable instructions, data structures, program modules and other data for the computer 210. In FIG. 2, for example, hard disk drive 241 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 20 through input devices such as a keyboard 262 and pointing device 261, commonly referred to as a mouse, trackball or touch pad. Other input devices (not shown) may include a microphone, joystick, game pad, satellite dish, scanner, or the like. These and other input devices are often connected to the processing unit 220 through a user input interface 260 that is coupled to the system bus, but may be connected by other interface and bus structures, such as a parallel port, game port or a universal serial bus (USB). A monitor 291 or other type of display device is also connected to the system bus 221 via an interface, such as a video interface 290. In addition to the monitor, computers may also include other peripheral output devices such as speakers 297 and printer 296, which may be connected through a output peripheral interface 290.

The computer 210 may operate in a networked environment using logical connections to one or more remote computers, such as a remote computer 280. The remote computer 280 may be a personal computer, a server, a router, a network PC, a peer device or other common network node, and typically includes many or all of the elements described above relative to the computer 210, although only a memory storage device 281 has been illustrated in FIG. 2. The logical connections depicted in FIG. 2 include a local area network (LAN) 271 and a wide area network (WAN) 273, but may also include other networks. Such networking environments are commonplace in offices, enterprise-wide computer networks, intranets and the Internet.

When used in a LAN networking environment, the computer 210 is connected to the LAN 271 through a network interface or adapter 270. When used in a WAN networking environment, the computer 210 typically includes a modem 272 or other means for establishing communications over the WAN 273, such as the Internet. The modem 272, which may be internal or external, may be connected to the system bus 221 via the user input interface 260, or other appropriate mechanism. In a networked environment, program modules depicted relative to the computer 210, or portions thereof, may be stored in the remote memory storage device. By way of example, and not limitation, FIG. 2 illustrates remote application programs 285 as residing on memory device 281. It will be appreciated that the network connections shown are exemplary and other means of establishing a communications link between the computers may be used.

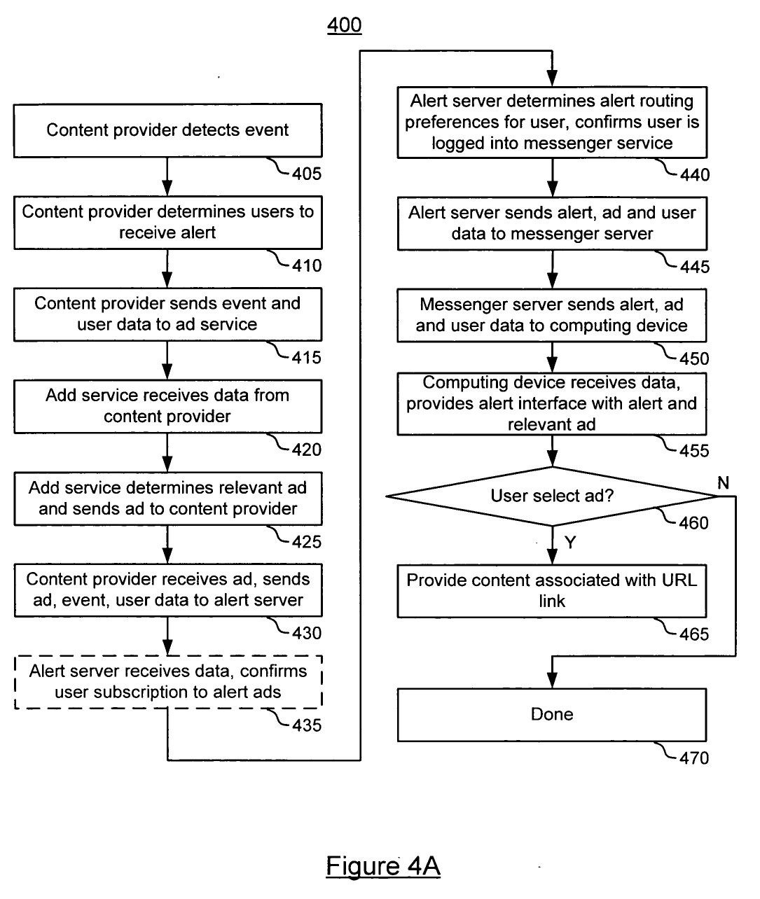

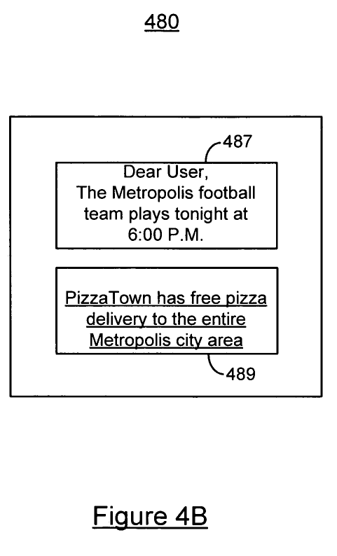

FIG. 3 illustrates an example of a sequence diagram 300 for partner-side retrieval of an advertisement for an alert. In partner-side retrieval of an advertisement, the advertisement is retrieved by a content provider located outside of advertisement generation system 105 of FIG. 1. With reference to FIG. 1, partner-side retrieval of an advertisement can be performed by content provider 110. Sequence diagram 300 includes content partner 110, advertisement service 130, alert server 125, user data store 128, messaging server 140, computing device 145, alert 360, and additional content 370. FIG. 4A illustrates an embodiment of a method for partner-side retrieval of a relevant advertisement. The method of FIG. 4A corresponds with sequence diagram 300. Communications illustrated in sequence diagram 300 are discussed concurrently with the discussion of FIG. 4A below.

FIG. 4A illustrates an embodiment of a method 400 for partner-side retrieval of a relevant advertisement. Content provider 110 detects an event at step 405. This is illustrated by step 305 of FIG. 3. In one embodiment, the event may be any event associated with a service the user has accepted or subscribed to. For example, a user may have subscribed to a weather service. In this case, when bad weather is forecasted to occur in user's area, the content provider may detect an event associated with a notification for the bad weather. In another example, the user may have subscribed to a sporting news service. In this case, when a local team in the user's area has a game that will be televised, an event may be generated to inform the user of the televised game. Events may be associated with other types of services and information as well, including news, an information trigger, an RSS feed, new search query result, or some other type of service or event.

Content provider 110 determines users to receive an alert at step 410. As discussed above, an alert will subsequently be generated from data associated with the detected event. Users to receive the alert can include users that have indicated a preference to receive information regarding the event detected at step 405. In one embodiment, content provider 110 may access a database or mailing list to determine which users shall receive the alert. The step of determining users to receive an alert is not illustrated in sequence diagram 300 of FIG. 3. Next, content provider 110 sends event and user data to advertisement service 130 at step 415. This is illustrated by step 310 of FIG. 3. The event data includes details of the event. For example, in the case of a bad weather alert, the event data may include the details of the weather, such as rain or snow, as well as the time the weather may occur and the location of the weather. The user data may include the name of the user, identification information for the user, and other meta-data for the user. Other meta-data may include information from a user profile, other alerts the user has subscribed to, address information for user, or other information. Advertisement service 130 receives the data from content provider 110 at step 420. Next, advertisement service 130 determines the relevant advertisement and sends the advertisement to content provider 110 at step 425. As discussed above, the advertisement to be provided with the alert is determined to be relevant to the alert. This is illustrated by step 315 of FIG. 3. As discussed above, an advertisement is selected which corresponds to the user and event data received by advertisement service 130.

In on embodiment, one or more relevant advertisements can be determined based on a textual analysis of the event and other data. In this case, a parsing engine (not illustrated in FIG. 1) within advertisement service 130 or another computing device of FIG. 1 may parse the text associated with the event data or alert itself. The parsed data may then be compared to one or more advertisement keywords. In some embodiments, the keywords are associated with different categories, such as geographical area, time and/or date, subject, etc. Each keyword, or combination of keywords, may be associated with an advertisement. For example, the event data or alert data may include text which reads, “The Metropolis football team plays tonight at 6:00 p.m.” In this case, the keywords may include “football”, “Metropolis”, and “6:00 p.m.” In particular, “football” may be detected as a keyword under a subject, events, or sporting events category, “Metropolis” may be detected as a keyword under a geographic category, and “6:00 p.m.” may be detected as a keyword under date and/or time category.

The advertisement can be selected based on the content of the event or alert data. In some cases, an advertisement associated with all the detected keywords may be considered more relevant than an advertisement associated with less than all the detected keywords in event or alert data. In the Metropolis football game example, an advertisement for a pizza delivery service associated with all three of the detected keywords may have a higher relevance than an advertisement for evening news updates associated with “Metropolis” and “6:00 p.m.”, and even more relevant than an advertisement for travel services for Metropolis, associated with the single keyword of “Metropolis.” The most relevant advertisement is selected and sent to the appropriate entity. With respect to textual analysis, the most relevant advertisement may be selected based on the number of matching keywords or phrases or based on the weight of the detected keywords. For example, if “Metropolis” was weighted more than “6:00 p.m.” or “football”, an advertisement associated with Metropolis itself (such as travel services to Metropolis) may be determined as the most relevant advertisement. This would differ from an advertisement selected for equally weighted keywords of “Metropolis”, “football” and “6:00 p.m.”

Content provider 110 receives the relevant advertisement and sends the relevant advertisement, event data, and user data to alert server 120 at step 430. This is illustrated by step 320 of FIG. 3. Next, alert server 120 receives the data from content provider 110 and, optionally, confirms the user's subscription to alert advertisements at step 435. In one embodiment, confirming a user's subscription to receive advertisements and alerts can be performed by alert server 120. In this case, alert server 120 may check with user data store 128 of FIG. 1, to determine whether the user has subscribed to the advertisement alert service. This is illustrated by step 325-330 of FIG. 3. In another embodiment, alert server 120 may store user preferences and subscriptions for advertisement alerts locally.

Alert server 120 determines alert routing preferences for the user at step 440. This is illustrated by step 335 of FIG. 3. An alert routing preference indicates how a user prefers to receive alerts. In one embodiment, a user may choose to receive an alert through an instant messaging service, a web-based mail service, a client application-based mail service, or a mobile device. In the embodiment illustrated in method 400 and time diagram 300, it is assumed that the user preference is to route alerts to the user through an instant messaging service. In this case, alert server 120 will then confirm whether or not the user is logged into the messenger service at step 440 as well. In one embodiment, alert server 120 may confirm a user is logged into a messenger service by sending a user online query to messaging server 140. In response to receiving a user online query, messaging server 140 may determine whether or not the user is currently logged in to the instant messaging service through messenger client application 147. Messaging server 140 then generates a response. Messaging server 140 then sends the user's online response back to alert server 120. This is illustrated by step 340-345 of FIG. 3.

In one embodiment, after confirming the user is logged into messaging server 140, alert server 120 generates the alert from the event data received from the content provider. The alert server then sends the alert, advertisement, and user data to messaging server 140 at step 445. This is illustrated by step 350 of FIG. 3. Messaging server 140 receives the data and sends the alert, advertisement, and user data to computing device 145 at step 455. This is illustrated by step 355 of FIG. 3.

Computing device 145 receives the alert, advertisement and user data and provides an alert interface with the alert and relevant advertisement at step 455. The alert interface is illustrated as alert 360 of FIG. 3. The alert interface contains the alert associated with the event data, as well as the relevant advertisement selected in response to the event data. An example of an alert interface is illustrated in FIG. 4B.

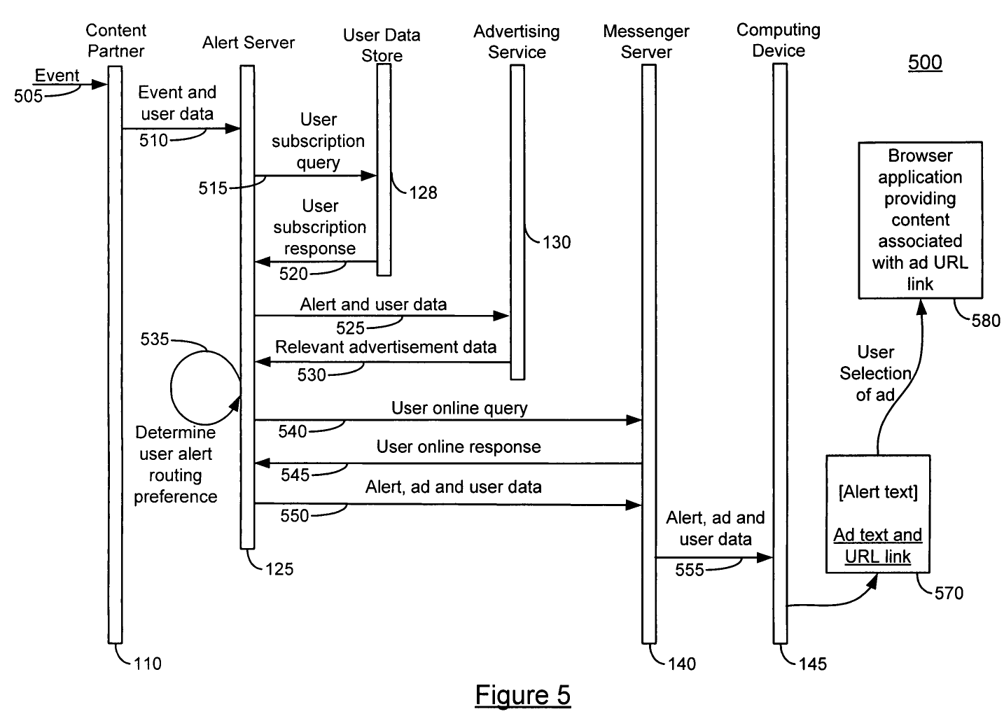

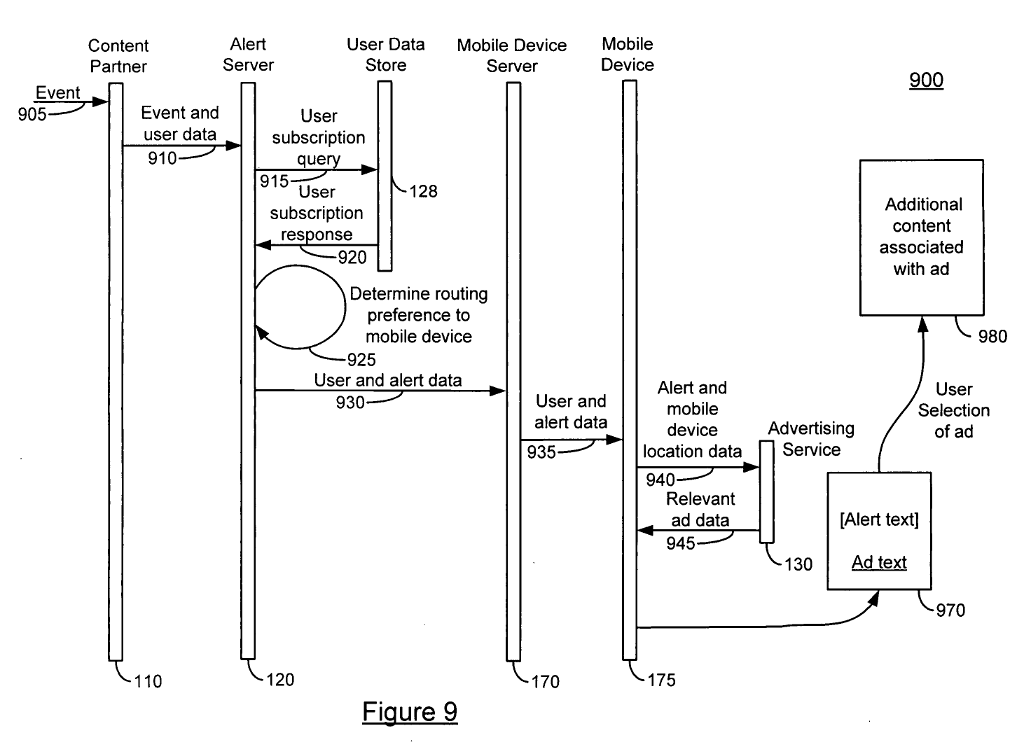

FIG. 4B illustrates an alert interface 480 having an advertisement and an alert. Alert interface 480 may be used to implement the alert interface 360 of FIG. 3, alert interface 570 of FIG. 5, alert interface 770 of FIG. 7, and alert interface 970 of FIG. 9. Alert interface 480 includes alert 487 and advertisement 489. Alert 487 includes text which reads, “Dear User, the Metropolis football team plays tonight at 6:00 P.M.” The relevant advertisement reads, “PizzaTown has free pizza delivery to the entire Metropolis city area.” Relevant advertisement 489 is related, or relevant, to alert 487 of alert interface 480. In particular, the alert provides information of a sporting event within the user's area at a particular time. The advertisement provides a related service, a food delivery service, in the user's area when the subject of the alert occurs.

Next, a determination is made as to whether the user has selected the advertisement of the alert interface at step 460. In one embodiment, a user may select the advertisement using an input device associated with computing device 145. In one embodiment, a determination is made with respect to a limited period of time in which the user may select the advertisement. If the user has not selected the advertisement within a designated period of time, operation continues to step 470 where operation of method 400 is complete. If the user does select the advertisement, operation continues to step 465. Additional content associated with the selected advertisement is provided at step 465. This is illustrated as content page 370 of FIG. 3. In one embodiment, where the advertisement is a link associated with a URL, a window is provided containing that URL. For example, in the case of a pizza delivery service, the URL may be a website providing more information for the company providing the pizza delivery. Operation of method 400 then ends at step 465.

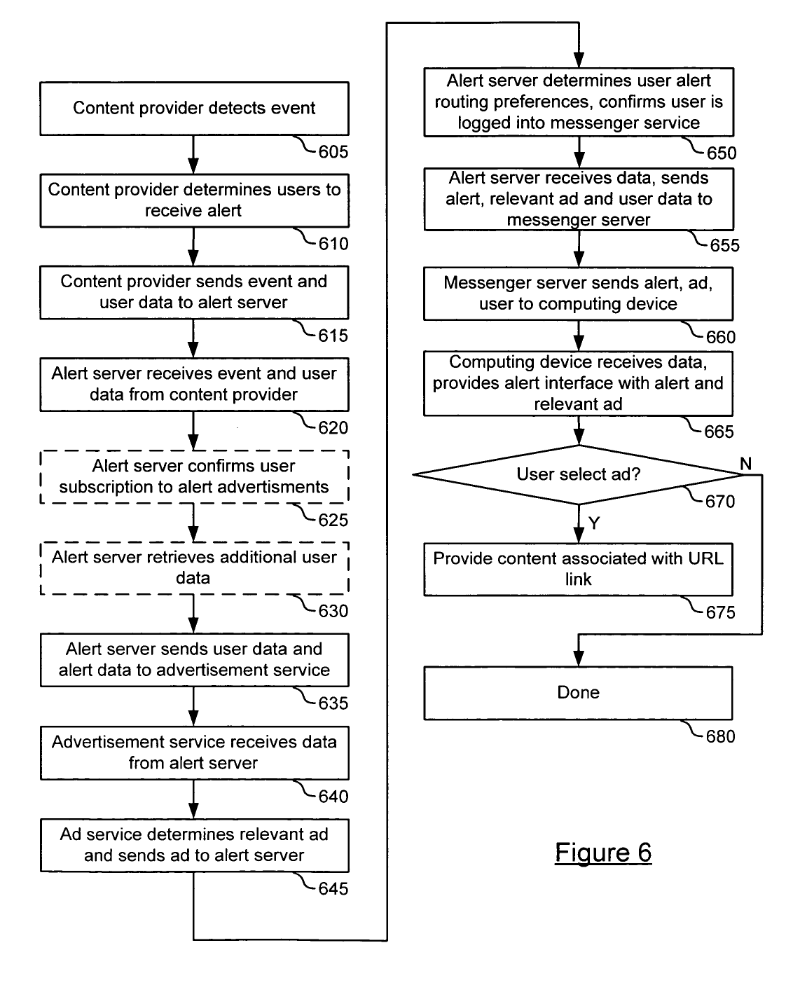

FIG. 5 is an example of a sequence diagram 500 for server-side retrieval of an advertisement for an alert. Sequence diagram 500 illustrates communications between content partner 110, alert server 120, user data store 128, advertisement service 130, messaging server 140, computing device 145, alert interface 570, and additional content window 580. FIG. 6 illustrates an embodiment of a method for server-side retrieval of a relevant advertisement. The method of FIG. 6 corresponds with sequence diagram 500. Communications illustrated in sequence diagram 500 are discussed concurrently with the discussion of FIG. 6 below.

FIG. 6 illustrates an embodiment of method 600 for server-side generation retrieval of an advertisement for an alert. Method 600 is similar to method 400 except that alert server 120 (rather than content provider 110) retrieves a relevant advertisement from advertisement service 130. Content provider 110 detects an event at step 605. This is illustrated by step 505 of FIG. 5. This step is similar to detection of an event at step 405 of method 400 discussed above. Content provider 110 then determines users to receive the alert at step 610. Next, content provider 110 sends event and user data to alert server 120 at step 615. This is illustrated by step 510 of FIG. 5. Alert server 120 receives the event user data from content provider 110 at step 620. Next, alert server 120 confirms a user subscription to alert advertisements at step 625. This is illustrated by step 515-520 of FIG. 5. Similar to step 435 of method 400, step 625 of method 600 is optional. Next, alert server 120 retrieves additional user data at step 630. Additional user data may be used to determine a more relevant ad to associate with the alert. Additional user data may be retrieved locally from alert server 120 or from a remote source, such as user data store 128 of FIG. 1. Additional user data may include user subscription data, travel history associated with a user (for example, reservations for airlines, hotels, and car rentals made by the user with an online service), and other meta-data as discussed herein. In one embodiment, retrieving additional user data is optional in method 600.

Alert server 120 sends the user data and alert data to advertisement service 130 at step 635. This is illustrated by step 525 of FIG. 5. This differs from a partner-side retrieval of an advertisement discussed in FIGS. 3-4 in that a server within the advertisement generation system provides the relevancy data to the advertisement service. In this case, content provider 110 typically provides alert server 120 with the event data and basic user data (such as user identification data), not the advertisement data.

Advertisement service 130 receives the user data and alert data from alert server 120 at step 640. Advertisement service 130 then determines a relevant advertisement and sends the relevant advertisement to alert server 120 at step 645. This is illustrated by step 530 of FIG. 5. As discussed above, the advertisement to be provided with the alert is determined to be relevant to the alert. Alert server 120 determines user alert routing preferences and confirms the user is logged into a messaging service at step 650. This is illustrated by step 535-540 of FIG. 5. As in method 400 discussed above, it is assumed throughout method 600 that the user preference is to deliver the alert to the user through an instant messaging service. If this was not the case, the system would not determine whether the user is logged in. Next, alert server 120 sends alert, relevant advertisement and user data to messaging server 140 at step 655. This is illustrated by step 550 of FIG. 5. Messaging server 140 receives the data and then sends the alert, advertisement and user data to computing device 145 at step 660. This is illustrated by step 555 of FIG. 5.

Computing device 145 receives the data and provides an alert interface to the user at step 665. The alert interface includes an alert based on the detected event, as well as the relevant advertisement selected from the event data. An example of an alert interface is illustrated by alert interface 570 of FIG. 5. A determination is then made at step 670 as to whether input is received from a user selecting the relevant advertisement within alert interface 570. In one embodiment, a determination is made with respect to whether the input was received within a limited period of time, for example the time the alert is displayed for the user. If input is received indicating the user has selected the advertisement at step 670, additional content is provided at step 675. In one embodiment, the additional content may be provided in a separate window as a result of the user's selection of a URL link. The additional content is represented by content page 580 of FIG. 5. Operation then ends at step 675. If the user did not select the ad within the advertisement interface at step 670, operation continues to step 680 where operation of method 600 is complete.

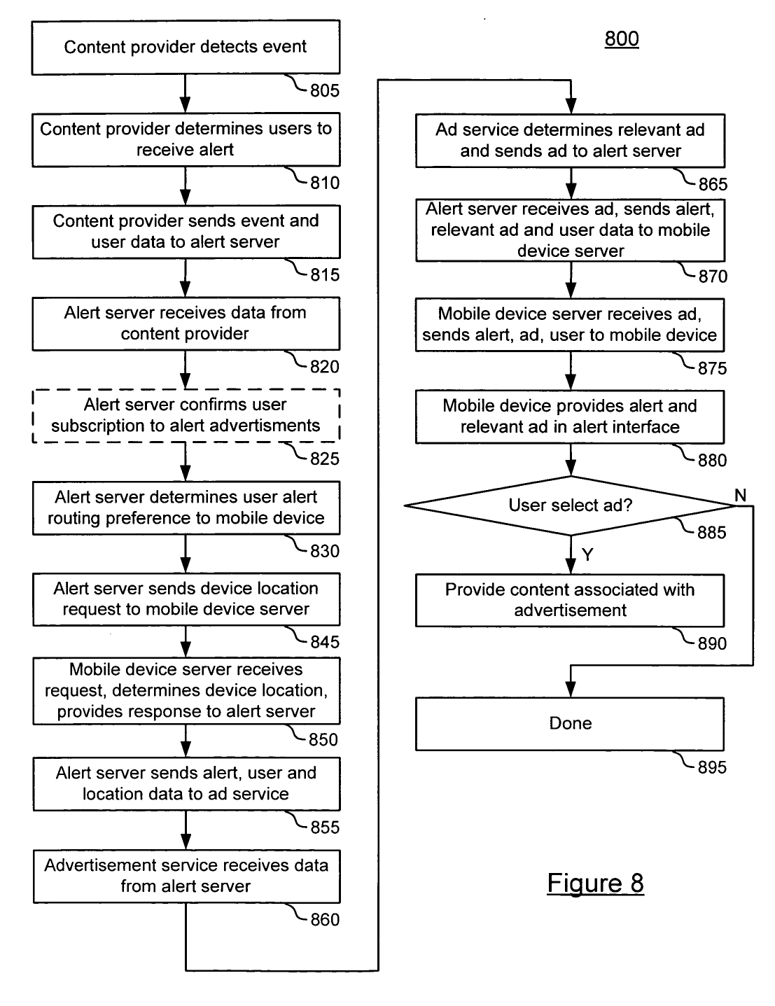

FIG. 7 illustrates a sequence diagram 700 of server-side retrieval of an advertisement for an alert. Sequence diagram 700 illustrates communication between content provider 110, alert server 120, user data store 128, advertising service 130, mobile device server 170, and mobile device 175. Sequence diagram 700 differs from sequence diagram 500 in that the meta-data used to select the alert includes location data for a user. In particular, location data for a mobile device associated with a user is retrieved from a mobile service server. The location data is then provided to advertising service 130 for selection of a relevant ad. FIG. 8 illustrates an embodiment of a method for server-side retrieval of a relevant advertisement. The method of FIG. 8 corresponds with sequence diagram 700. Communications illustrated in sequence diagram 700 are discussed concurrently with the discussion of FIG. 8 below.

FIG. 8 illustrates an embodiment of a method 800 for server-side retrieval of an advertisement for an alert. Method 800 is similar to method 600 except that the user receives an alert through a mobile device and mobile device location data is determined before selecting a relevant advertisement. Content provider 110 detects an event at step 805. This is illustrated by step 705 of FIG. 7. Content provider 110 determines users to receive an alert based on the detected event at step 810. Content provider 110 then sends event and user data to alert server 120 at step 815. This is illustrated by step 710 of FIG. 7. Alert server 120 receives the data from content provider 110 at step 820. In one embodiment, alert server 120 confirms a user's subscription to alert advertisements at step 825. User subscription confirmation may be done locally or by querying user data store 128. User subscription confirmation performed by querying user data store 128 is illustrated by steps 715-720 of FIG. 7.

Alert server 125 determines a user alert routing preference to receive alerts at a mobile device at step 830. This is illustrated by step 725 of FIG. 7. This determination differs from previously discussed advertisement generation methods wherein the routing preference is determined to be to an instant messaging service. Once a routing preference to a mobile device is identified, the location of the mobile device may be determined. Alert server 120 sends a device location request to mobile service server 170 at step 845. This is illustrated by step 730 of FIG. 7. Mobile service server 170 receives the request, determines the user device location, and provides a response to alert server 120 at step 850. This is illustrated by step 735 of FIG. 7. In one embodiment, the mobile service server may determine the mobile device's location using GPS information inherent in the mobile device. For example, most modem cell phones utilize GPS information and are capable of transmitting this information to a mobile service server. Other mobile devices may utilize this information as well. In some embodiments, the location information may include a zip code, city, state or country in which the user is currently located. This can be determined from the GPS information in the user's mobile device or phone.

After mobile service server 170 has determined the device location and sent a response to alert server 120, alert server 120 sends alert user and location data to advertisement service 130. This is illustrated by step 740 of FIG. 7. Unlike methods 400 and 600 discussed above, the transmission by alert server 120 at step 855 includes actual location data for the user. Advertisement service 130 receives the alert, user and location data from alert server 120 at step 860. Advertisement service 130 then determines a relevant advertisement and sends the advertisement to alert server 120 at step 865. As discussed above, the advertisement to be provided with the alert is determined to be relevant to the alert. This is illustrated by step 745 of FIG. 7. The relevant advertisement is selected using the alert content, user data, and location data determined by mobile service server 170.

Upon receiving the relevant advertisement from advertisement service 130, alert server 120 sends the alert, relevant advertisement and user data to mobile service server 170 at step 870. This is illustrated by step 750 of FIG. 7. Mobile service server 170 then sends the alert, advertisement, and user data to the user's mobile device 175 at step 875. This is illustrated by step 755 of FIG. 7. Mobile device 175 receives the data and provides an alert interfaced, including an alert and relevant advertisement, to a user at step 880. This is illustrated by step 770 of FIG. 7. In one embodiment, the alert and relevant advertisement is provided to a user through a mobile device display system, such as the display of a cellular phone. A determination is then made as to whether a user selects the advertisement at step 885. In one embodiment, a determination is made with respect to a limited period of time for which the alert interface is displayed for the user. If user selects the advertisement, operation continues to step 890. If the advertisement is not selected, then operation is complete at step 895.

In one embodiment, a user may select the advertisement using navigational keys on the mobile device. For example, arrow keys on a cell phone key pad may be used to navigate a cell phone display and select the relevant advertisement provided on the mobile device display. At step 890, after user selection of the advertisement has been determined, additional content associated with the relevant advertisement is displayed for the user. This is illustrated as content page 780 in FIG. 780. Operation of method 800 is then complete.

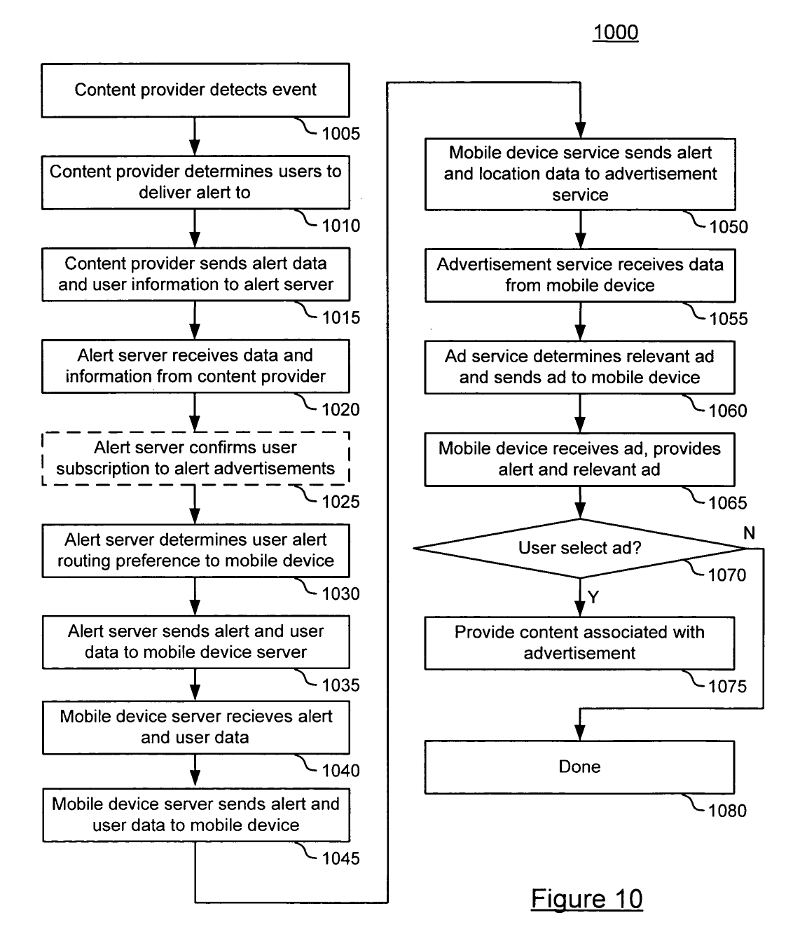

FIG. 9 illustrates an embodiment of a sequence diagram 900 of client-side retrieval of an advertisement for an alert. Sequence diagram 900 includes content provider 110, alert server 120, mobile service server 170, mobile device 175, advertising service 130, alert interface 970, and content window 980. Sequence diagram 900 differs from previously discussed sequence diagram herein in that mobile device 175 generates the alert to provide to a user. In particular, event data is provided to the mobile device. In response, the mobile device determines the location of the user and provides this information to advertising service 130. Mobile device 175 then generates the alert and provides the alert to a user. FIG. 10 illustrates an embodiment of a method for client-side retrieval of a relevant advertisement. The method of FIG. 10 corresponds with sequence diagram 900. Communications illustrated in sequence diagram 900 are discussed concurrently with the discussion of FIG. 10 below.

FIG. 10 illustrates an embodiment of a method 1000 for client-side retrieval of an advertisement for an alert. Method 1000 differs from method 800 in that the client device, in this case mobile device 175, retrieves the relevant advertisement using alert, user and location data. Method 1000 begins with content provider 110 detecting an event at step 1005. This is illustrated by step 905 of FIG. 9. Next, content provider 110 determines users to deliver an alert to at step 1010. Content provider 110 then sends alert data and user data to alert server 120 at step 1015. This is illustrated by step 910 of FIG. 9. Alert server 120 receives the alert data and user data from content provider 110 at step 1020. Optionally, alert server 120 then confirms a user's subscription to alert advertisements at step 1025. Confirmation of a user's subscription to alert advertisements via a query to user data store 128 is illustrated by steps 915-920 of FIG. 9. Alert server 120 then determines a user alert routing preference to a mobile device for the user at step 1030. This is illustrated by step 925 of FIG. 9. Alert server 120 then sends alert data and user data to mobile service server 170 at step 1035. This is illustrated by step 930 of FIG. 9. Mobile service server 170 receives alert and user data from alert server 120 at step 1040. Mobile service server 170 then sends the alert and user data to mobile device 175 at step 1045. This is illustrated by step 935 of FIG. 9. Mobile device 175 sends the received alert, and user data, and location data to advertisement service 130 at step 1050. This is illustrated by step 940 of FIG. 9. In this case, the client device is sending a query to the advertisement service for the relevant advertisement. The location data sent by mobile device 175 to advertisement service 130 is determined locally by mobile device 175. In another embodiment, the location data is determined by mobile service server 170 and transmitted to mobile device 175 along with the alert data and user data at step 1045. Advertisement service 130 receives data from mobile device 175 at step 1055. Advertisement service 130 then determines the relevant advertisement and sends this advertisement to mobile device 175 at step 1060. This is illustrated by step 945 of FIG. 9. As discussed above, the advertisement to be provided with the alert is determined to be relevant to the alert. Upon receiving the relevant advertisement, mobile device 175 provides the relevant advertisement and alert to the user at step 1065. This is illustrated as alert interface 970 in FIG. 9. In one embodiment, the alert and advertisement are provided in a display mechanism of the mobile device, such as a mobile device LCD. A determination is then made at step 1070 as to whether the user has selected the relevant advertisement at step 1070. In one embodiment, a determination is made with respect to a limited period of time in which the user may select the advertisement. If the user does not select the advertisement provided by mobile device 175, operation of method 1000 is complete at step 1080. If the user has selected the advertisement, operation continues to step 1075. At step 1075, mobile device 175 provides content associated with the relevant advertisement to the user in the display mechanism of the mobile device. This is illustrated by content page 980 of FIG. 9. Operation of method 1000 is then complete.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

We claim:

1. A method for providing an alert, comprising:
receiving event data associated with an alert for a user;
determining a relevant advertisement associated with the event data; and
providing the relevant advertisement and the alert to the user.

2. The method of claim 1, wherein the event data includes location information for a mobile device.

3. The method of claim 1, wherein the event data includes time data, the relevant advertisement determined in part from the time data.

4. The method of claim 1, wherein said step of determining a relevant advertisement includes:
receiving the relevant advertisement in response to transmitting the event data.

5. The method of claim 1, wherein said step of providing the relevant advertisement and an alert to the user includes:
determining a user routing preference for receiving alerts.

6. The method of claim 1, wherein the relevant advertisement includes a URL link in an alert interface.

7. The method of claim 1, wherein said step of providing the relevant advertisement and an alert to the user includes:
providing an alert through an instant messaging service.

8. The method of claim 1, wherein said step of providing the relevant advertisement and an alert to the user includes:
providing an alert to a mobile device.

9. The method of claim 1, wherein said step of providing the relevant advertisement and an alert to the user includes:
providing an alert through a mail service.

10. A system for providing an alert, comprising:
an alert generation engine able to generate an alert in response to receiving event data for a user, the alert having alert data and advertisement data; and
an alert delivery engine able to deliver the alert to a user.

11. The system of claim 10, wherein the event data includes location data for a mobile device.

12. The system of claim 10, wherein the event data includes time data associated with the event data.

13. The system of claim 10, wherein said alert generation engine is able to retrieve advertising data associated with the event data.

14. The system of claim 10, wherein said alert delivery engine provides an interface containing an advertisement and the alert, the advertisement associated with the advertisement data.

15. The system of claim 14, wherein said alert delivery engine provides the alert and advertisement to a user through a mobile device.

16. The system of claim 14, wherein said alert delivery engine provides the alert and advertisement to a user through an instant messaging application.

17. A method for providing an alert, comprising:
receiving alert data and advertisement data by an application, the alert data and advertisement data associated with a user; and
providing the alert data and advertisement data to the user in an alert interface.

18. The method of claim 17, wherein the alert interface is provided through an instant messaging system.

19. The method of claim 17, wherein the alert interface is provided through a mobile device.

20. The method of claim 17, wherein said step of receiving alert data and advertisement data includes:
receiving alert data by the application; and
retrieving advertisement data by the application in response to said receiving alert data.
